(19) United States
(12) Patent Application Publication
(10) Pub. No.: US 2023/0157505 A1
(43) Pub. Date: May 25, 2023

(54) ROBOT CLEANER AND METHOD OF CONTROLLING ROBOT CLEANER

(71) Applicant: LG ELECTRONICS INC., Seoul (KR)

(72) Inventors: Inbo SHIM, Seoul (KR); Yonggil SHIN, Seoul (KR); Gayeon KIM, Seoul (KR)

(73) Assignee: LG ELECTRONICS INC., Seoul (KR)

(21) Appl. No.: 17/921,003

(22) PCT Filed: Apr. 23, 2021
(86) PCT No.: PCT/KR2021/005146

§ 371 Date: Oct. 24, 2022

(30) Foreign Application Priority Data
Apr. 24, 2020 (KR) 10-2020-0050234

(51) Int. Cl. A47L 11/40

(52) U.S. Cl. CPC A47L 11/40; A47L 2201/04

(57) ABSTRACT

The present disclosure relates to a method of controlling a robot cleaner including a pair of rotary plates having lower sides to which mops facing a floor surface are coupled, the robot cleaner being configured to move by rotating the pair of rotary plates, the method including: a first forward movement step of moving the robot cleaner forward from a starting point toward a predetermined target point; a first rotation step of rotating the robot cleaner; a second forward movement step of moving the robot cleaner forward after the first rotation step; and a second rotation step of rotating the robot cleaner after the second forward movement step, such that the floor surface may be repeatedly cleaned only by the forward movement and the rotation.

### TECHNICAL FIELD

The present disclosure relates to a robot cleaner and a method of controlling the robot cleaner, and more particularly, to a robot cleaner capable of rotating a mop of the robot cleaner and moving and cleaning a floor using a frictional force between the mop and the floor, and a method of controlling the robot cleaner.

### BACKGROUND ART

Recently, with the development of industrial technologies, a robot cleaner has been developed which performs a cleaning operation while autonomously moving in a zone required to be cleaned without a user's manipulation. Such a robot cleaner has a sensor capable of recognizing a space to be cleaned, and a mop capable of cleaning a floor surface, such that the robot cleaner may move while wiping, with the mop, the floor surface in the space recognized by the sensor.

Among the robot cleaners, there is a wet robot cleaner capable of wiping a floor surface with a mop containing moisture in order to effectively remove foreign substances strongly attached to the floor surface. The wet robot cleaner has a water container and is configured such that water accommodated in the water container is supplied to the mop and the mop containing moisture wipes the floor surface to effectively remove the foreign substances strongly attached to the floor surface.

The mop of the wet robot cleaner has a circular shape and is configured to wipe the floor surface while rotating in a state of being in contact with the floor surface. In addition, the robot cleaner is sometimes configured to move in a particular direction using a frictional force generated when a plurality of mops rotates in a state of being in contact with the floor surface.

Meanwhile, as the frictional force between the mop and the floor surface increases, the mop may strongly wipe the floor surface, such that the robot cleaner may effectively clean the floor surface.

Meanwhile, a general wet mop robot cleaner continuously moves forward until the robot cleaner recognizes an obstacle, and when the obstacle is detected, the robot cleaner may change a direction thereof and then move.

However, in a case in which the floor surface is severely contaminated and thus needs to be repeatedly and precisely cleaned by the mop, there is a limitation in clearly clean the floor surface.

Meanwhile, Korean Patent No. KR 0677253 B1 (Jan. 26, 2007) discloses a robot cleaner that cleans a region locally contaminated.

The robot cleaner may clean the locally contaminated region while moving on the floor surface while forming a spiral pattern.

However, in the case in which the robot cleaner spirally rotates as described above, some cleaning areas overlap one another, but there is a limitation in concentratedly and repeatedly clean a center of a mainly contaminated region.

### DISCLOSURE

### Technical Problem

The present disclosure has been made in an effort to solve the above-mentioned problems of the robot cleaner and the method of controlling the robot cleaner in the related art, and an object of the present disclosure is to provide a robot cleaner and a method of controlling the robot cleaner, which are configured to repeatedly clean a floor surface.

Another object of the present disclosure is to provide a robot cleaner and a method of controlling the robot cleaner, which are capable of precisely cleaning a severely contaminated floor surface.

Still another object of the present disclosure is to provide a robot cleaner and a method of controlling the robot cleaner, which are configured to reduce the time required to move the robot cleaner and perform a cleaning operation.

Yet another object of the present disclosure is to provide a robot cleaner and a method of controlling the robot cleaner, which are capable of cleaning a widely contaminated region around a specific point on a floor surface.

### Technical Solution

In order to achieve the above-mentioned objects, the present disclosure provides a robot cleaner including: a main body having a bumper provided on a front surface thereof and having a space for accommodating a battery, a water container, and a motor therein; and a pair of rotary plates rotatably disposed on a bottom surface of the main body and having lower sides to which mops facing a floor surface are coupled.

The main body may rectilinearly move in a predetermined cleaning region on the floor surface, and when the main body reaches an outer peripheral boundary of the cleaning region, the main body may rotate toward an inside of the cleaning region and then move rectilinearly.

The cleaning region may be a circular region having a predetermined radius on the floor surface.

The main body may rotate by a preset angle at an outer peripheral boundary of the cleaning region.

The main body may rotate by a random angle at the outer peripheral boundary of the cleaning region.

The main body may move in a circular cleaning region having a predetermined radius on the floor surface, and the main body may start from a predetermined starting point on a circumference of the cleaning region and move to a predetermined direction change point on the circumference of the cleaning region.

The main body may start from the direction change point and move to a predetermined target point on a circumference of the cleaning region, and the target point may be different from the starting point.

In order to achieve the above-mentioned objects, the present disclosure provides a method of controlling a robot cleaner including a pair of rotary plates having lower sides to which mops facing a floor surface are coupled, the robot cleaner being configured to move by rotating the pair of rotary plates, the method including: a movement step of allowing the robot cleaner to start from a starting point positioned on an outer periphery of a cleaning region set on the floor surface and move to a direction change point positioned on the outer periphery of the cleaning region; and a direction change step of rotating the robot cleaner at the direction change point toward an inside of the cleaning region.

The robot cleaner may move rectilinearly to the predetermined direction change point in the movement step.

The method of controlling the robot cleaner according to the present disclosure may further include a region setting step of setting the cleaning region on the floor surface before the movement step.

The region setting step may set the cleaning region by forming an imaginary circle having a predetermined radius around a predetermined origin.

The method of controlling the robot control according to the present disclosure may further include a movement preparation step of disposing the robot cleaner at an initial starting point before the movement step.

The direction change step may rotate the robot cleaner by a predetermined direction change angle.

The direction change step may rotate the robot cleaner by a random angle.

The direction change step may reset the direction change point in the movement step as the starting point, reset any one point on the outer periphery of the cleaning region as the direction change point, and rotate the robot cleaner toward the reset direction change point.

The method of controlling the robot cleaner according to the present disclosure may perform the movement step again after the direction change step and stop the robot cleaner after repeating the movement step a predetermined number of times.

The method of controlling the robot cleaner according to the present disclosure may perform the movement step again after the direction change step and stop the robot cleaner when a predetermined cleaning time elapses after the robot cleaner starts from an initial starting point.

### Advantageous Effect

According to the robot cleaner and the method of controlling the robot cleaner according to the present disclosure described above, the robot cleaner moves across the cleaning region while moving between the plurality of direction change points. As a result, the robot cleaner may clean the circular cleaning region while repeatedly moving in the circular cleaning region.

In addition, the robot cleaner may precisely clean the severely contaminated floor surface while reciprocating in the severely contaminated floor surface.

In addition, the robot cleaner may clean a widely contaminated region around a specific point on the floor surface.

### DESCRIPTION OF DRAWINGS

FIG. 1 is a perspective view illustrating a robot cleaner according to an embodiment of the present disclosure.

FIG. 2 is a view illustrating some components separated from the robot cleaner illustrated in FIG. 1.

FIG. 3 is a rear view illustrating the robot cleaner illustrated in FIG. 1.

FIG. 4 is a bottom plan view illustrating the robot cleaner according to the embodiment of the present disclosure.

FIG. 5 is an exploded perspective view illustrating the robot cleaner.

FIG. 6 is a cross-sectional view schematically illustrating the robot cleaner and components of the robot cleaner according to the embodiment of the present disclosure.

FIG. 7 is a view for explaining a movement direction of the robot cleaner according to the embodiment of the present disclosure.

FIG. 8 is a schematic view illustrating the robot cleaner according to the embodiment of the present disclosure when viewed from above.

FIG. 9 is a block diagram of the robot cleaner according to the embodiment of the present disclosure.

FIG. 10 is a flowchart illustrating a method of controlling the robot cleaner according to the embodiment of the present disclosure.

FIG. 11 is a view for explaining a process in which the robot cleaner sets a cleaning region in accordance with the method of controlling the robot cleaner according to the embodiment of the present disclosure.

FIGS. 12 to 16 are views for schematically explaining routes along which the robot cleaner moves in accordance with the method of controlling the robot cleaner according to the embodiment of the present disclosure.

FIG. 17 is a view for schematically explaining a route along which the robot cleaner moves in accordance with a method of controlling the robot cleaner according to another embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terms used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

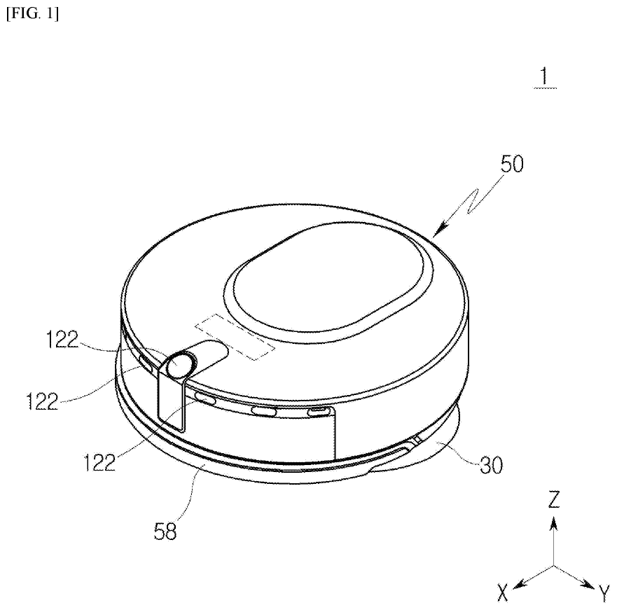

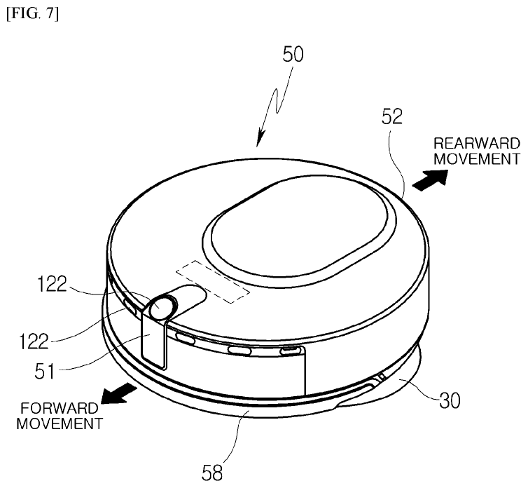

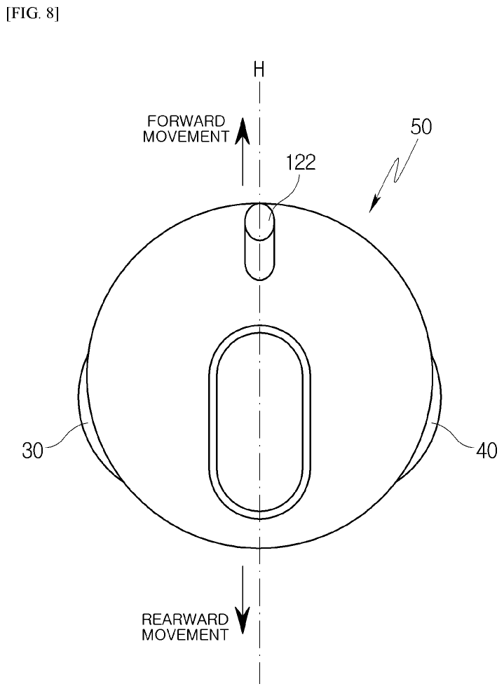

FIGS. 1 to 6 are structural views for explaining a structure of a robot cleaner according to an embodiment of the present disclosure, and FIGS. 7 and 8 are views for explaining movement directions of the robot cleaner according to the embodiment of the present disclosure.

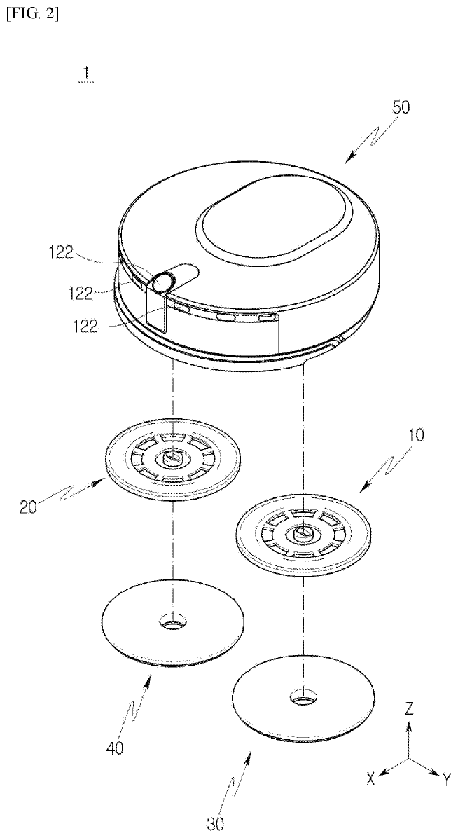

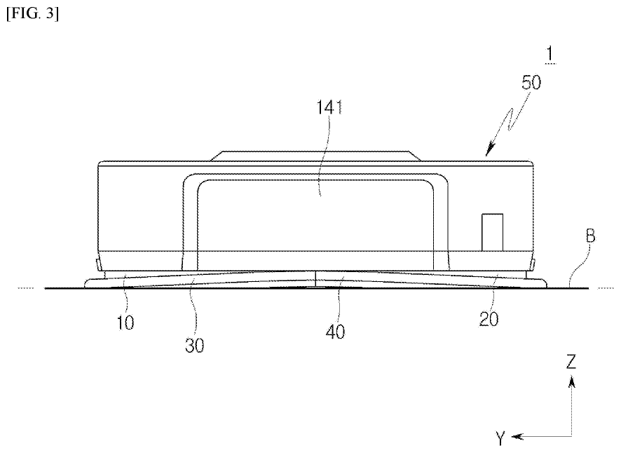

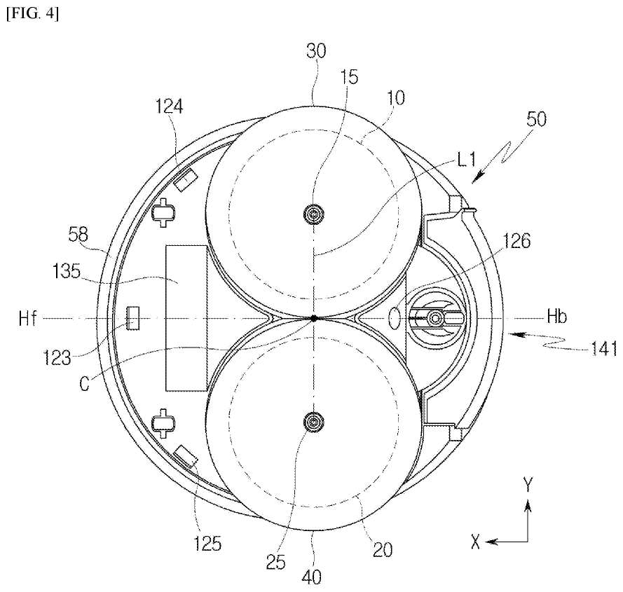

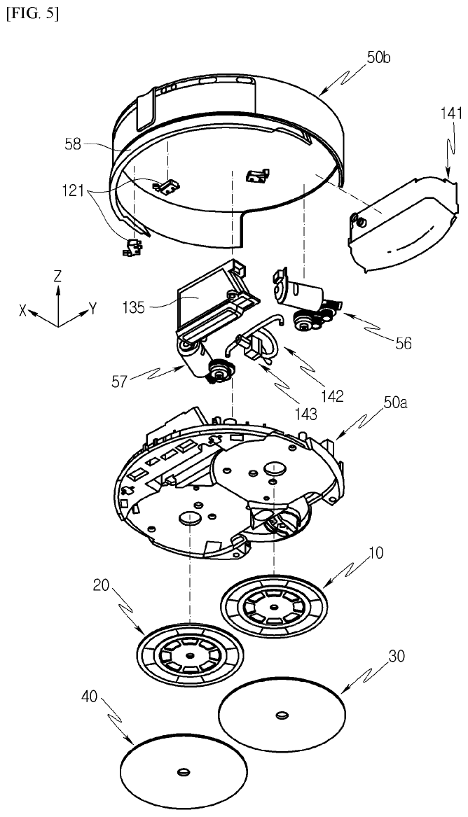

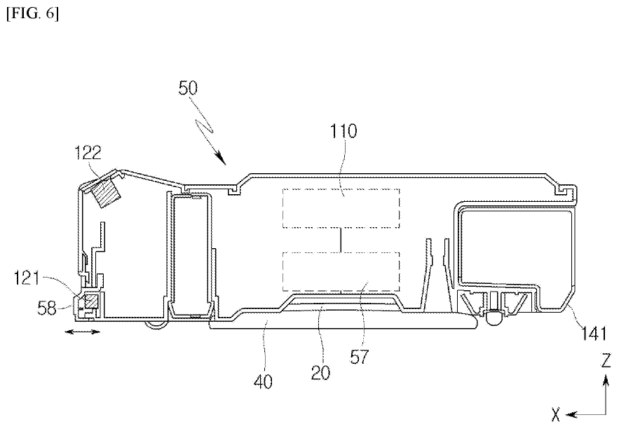

More specifically, FIG. 1 is a perspective view illustrating a robot cleaner 1, FIG. 2 is a view illustrating some components separated from the robot cleaner 1, FIG. 3 is a rear view of the robot cleaner 1, FIG. 4 is a bottom plan view of the robot cleaner 1, FIG. 5 is an exploded perspective view of the robot cleaner 1, and FIG. 6 is a cross-sectional view illustrating an interior of the robot cleaner 1.

A structure of the robot cleaner 1 according to the present disclosure will be described below with reference to FIGS. 1 to 8.

The robot cleaner 1 is configured to be placed on a floor and clean the floor using mops while moving on a floor surface B. Therefore, hereinafter, a vertical direction is defined based on a state in which the robot cleaner 1 is placed on the floor.

Further, a side at which a first lower sensor 123 to be described below is defined as a front side based on a first rotary plate 10 and a second rotary plate 20.

Among the portions described in the present disclosure, a ‘lowermost portion’ may be a portion positioned at a lowest position or a portion closest to the floor when the robot cleaner 1 is placed on the floor and used.

The robot cleaner 1 may include a main body 50, rotary plates 10 and 20, and mops 30 and 40. In this case, the rotary plates 10 and 20 may be provided in a pair and include a first rotary plate 10 and a second rotary plate 20, and the mops 30 and 40 may include a first mop 30 and a second mop 40.

The main body 50 may define an entire external shape of the robot cleaner 1 or may be provided in the form of a frame. Components constituting the robot cleaner 1 may be coupled to the main body 50, and some of the components constituting the robot cleaner 1 may be accommodated in the main body 50. The main body 50 may be divided into a lower main body 50a and an upper main body 50b. The components of the robot cleaner 1 including a battery 135, a water container 141, and motors 56 and 57 are provided in a space defined by coupling the lower main body 50a and the upper main body 50b (see FIG. 5).

The first rotary plate 10 may be rotatably disposed on a bottom surface of the main body 50, and the first mop 30 may be coupled to a lower side of the first rotary plate 10.

The first rotary plate 10 has a predetermined area and is provided in the form of a flat plate, a flat frame, or the like. The first rotary plate 10 is laid approximately horizontally, such that a width (or a diameter) in the horizontal direction is sufficiently larger than a height in the vertical direction thereof. The first rotary plate 10 coupled to the main body 50 may be parallel to the floor surface B or inclined with respect to the floor surface B. The first rotary plate 10 may be provided in the form of a circular plate, a bottom surface of the first rotary plate 10 may be approximately circular, and the first rotary plate 10 may entirely have a rotationally symmetrical shape.

The second rotary plate 20 may be rotatably disposed on the bottom surface of the main body 50, and the second mop 40 may be coupled to a lower side of the second rotary plate 20.

The second rotary plate 20 has a predetermined area and is provided in the form of a flat plate, a flat frame, or the like. The second rotary plate 20 is laid approximately horizontally, such that a width (or a diameter) in the horizontal direction thereof is sufficiently larger than a height in the vertical direction thereof. The second rotary plate 20 coupled to the main body 50 may be parallel to the floor surface B or inclined with respect to the floor surface B. The second rotary plate 20 may be provided in the form of a circular plate shape, a bottom surface of the second rotary plate 20 may be approximately circular, and the second rotary plate 20 may entirely have a rotationally symmetrical shape.

In the robot cleaner 1, the second rotary plate 20 may be identical to the first rotary plate 10 or the second rotary plate 20 and the first rotary plate 10 may be provided symmetrically. When the first rotary plate 10 is positioned at a left side of the robot cleaner 1, the second rotary plate 20 may be positioned at a right side of the robot cleaner 1. In this case, the first rotary plate 10 and the second rotary plate 20 may be vertically symmetric.

The first mop 30 may be coupled to the lower side of the first rotary plate 10 so as to face the floor surface B.

A bottom surface of the first mop 30, which is directed toward the floor, has a predetermined area, and the first mop 30 has a flat shape. The first mop 30 is configured such that a width (or a diameter) in the horizontal direction thereof is sufficiently larger than a height in the vertical direction thereof When the first mop 30 is coupled to the main body 50, the bottom surface of the first mop 30 may be parallel to the floor surface B or inclined with respect to the floor surface B.

The bottom surface of the first mop 30 may be approximately circular, and the first mop 30 may entirely have a rotationally symmetrical shape. In addition, the first mop 30 may be attached to or detached from the bottom surface of the first rotary plate 10. The first mop 30 may be coupled to the first rotary plate 10 and rotate together with the first rotary plate 10.

The second mop 40 may be coupled to the lower side of the second rotary plate 20 so as to face the floor surface B.

A bottom surface of the second mop 40, which is directed toward the floor, has a predetermined area, and the second mop 40 has a flat shape. The second mop 40 is configured such that a width (or a diameter) in the horizontal direction thereof is sufficiently larger than a height in the vertical direction thereof When the second mop 40 is coupled to the main body 50, the bottom surface of the second mop 40 may be parallel to the floor surface B or inclined with respect to the floor surface B.

The bottom surface of the second mop 40 may be approximately circular, and the second mop 40 may entirely have a rotationally symmetrical shape. In addition, the second mop 40 may be attached to or detached from the bottom surface of the second rotary plate 20. The second mop 40 may be coupled to the second rotary plate 20 and rotate together with the second rotary plate 20.

When the first rotary plate 10 and the second rotary plate 20 rotate in opposite directions at the same velocity, the robot cleaner 1 may move forward or rearward in a straight direction. For example, when the first rotary plate 10 rotates counterclockwise and the second rotary plate 20 rotates clockwise when viewed from above, the robot cleaner 1 may move forward.

When only any one of the first rotary plate 10 and the second rotary plate 20 rotates, the robot cleaner 1 may change the direction thereof and turn.

When a rotational velocity of the first rotary plate 10 and a rotational velocity of the second rotary plate 20 are different from each other or the first rotary plate 10 and the second rotary plate 20 rotate in the same direction, the robot cleaner 1 may move while changing the direction thereof and move in a curved direction.

The robot cleaner 1 may further include the first lower sensor 123.

The first lower sensor 123 is provided at the lower side of the main body 50 and configured to detect a relative distance to the floor B. The first lower sensor 123 may be variously configured as long as the first lower sensor 123 may detect the relative distance between the floor surface B and the point at which the first lower sensor 123 is provided.

When the relative distance to the floor surface B (a distance in the vertical direction from the floor surface or a distance in the direction inclined with respect to the floor surface), which is detected by the first lower sensor 123, exceeds a predetermined value or exceeds a predetermined range, this may be a case in which the floor surface is rapidly lowered. Therefore, the first lower sensor 123 may detect a cliff.

The first lower sensor 123 may be an optical sensor and include a light-emitting portion for emitting light, and a light-receiving portion for receiving reflected light. The first lower sensor 123 may be an infrared sensor.

The first lower sensor 123 may be referred to as a cliff sensor.

The robot cleaner 1 may further include a second lower sensor 124 and a third lower sensor 125.

When an imaginary line, which connects a center of the first rotary plate 10 and a center of the second rotary plate 20 in the horizontal direction (the direction parallel to the floor surface B), is a connection line L1, the second lower sensor 124 and the third lower sensor 125 may be provided at the lower side of the main body 50 and disposed at the same side as the first lower sensor 123 based on the connection line L1. The second lower sensor 124 and the third lower sensor 125 may be configured to detect the relative distance to the floor B (see FIG. 4).

The third lower sensor 125 may be provided at a side opposite to the second lower sensor 124 based on the first lower sensor 123.

Each of the second lower sensor 124 and the third lower sensor 125 may be variously configured as long as each of the second lower sensor 124 and the third lower sensor 125 may detect the relative distance to the floor surface B. Each of the second lower sensor 124 and the third lower sensor 125 may be identical to the first lower sensor 123 except for the positions at which the sensors are provided.

The robot cleaner 1 may further include the first motor 56, the second motor 57, the battery 135, the water container 141, and a water supply tube 142.

The first motor 56 may be coupled to the main body 50 and configured to rotate the first rotary plate 10. Specifically, the first motor 56 may be an electric motor coupled to the main body 50, and one or more gears may be connected to the first motor 56 to transmit a rotational force to the first rotary plate 10.

The second motor 57 may be coupled to the main body 50 and configured to rotate the second rotary plate 20. Specifically, the second motor 57 may be an electric motor coupled to the main body 50, and one or more gears may be connected to the second motor 57 to transmit a rotational force to the second rotary plate 20.

As described above, in the robot cleaner 1, the first rotary plate 10 and the first mop 30 may be rotated by the operation of the first motor 56, and the second rotary plate 20 and the second mop 40 may be rotated by the operation of the second motor 57.

The second motor 57 and the first motor 56 may be symmetric (vertically symmetric).

The battery 135 may be coupled to the main body 50 and configured to supply power the other components constituting the robot cleaner 1. The battery 135 may supply power to the first motor 56 and the second motor 57.

The battery 135 may be charged with external power. To this end, a charging terminal for charging the battery 135 may be provided at one side of the main body 50 or provided on the battery 135.

In the robot cleaner 1, the battery 135 may be coupled to the main body 50.

The water container 141 is provided in the form of a container having an internal space that stores therein a liquid such as water. The water container 141 may be fixedly coupled to the main body 50 or detachably coupled to the main body 50.

In the robot cleaner 1, the water supply tube 142 is provided in the form of a tube or a pipe and connected to the water container 141 so that the liquid in the water container 141 may flow through the inside of the water supply tube 142. An end of the water supply tube 142, which is opposite to the side at which the water supply tube 142 is connected to the water container 141, is provided above the first rotary plate 10 and the second rotary plate 20, such that the liquid in the water container 141 may be supplied to the first mop 30 and the second mop 40.

In the robot cleaner 1, the water supply tube 142 may be provided in a shape having two tube portions diverged from a single tube portion. In this case, an end of one diverged tube portion may be positioned above the first rotary plate 10, and an end of the other diverged tube portion may be positioned above the second rotary plate 20.

The robot cleaner 1 may have a separate water pump 143 to move the liquid through the water supply tube 142.

The robot cleaner 1 may further include a bumper 58, a first sensor 121, and a second sensor 122.

The bumper 58 is coupled along a rim of the main body 50 and configured to move relative to the main body 50. For example, the bumper 58 may be coupled to the main body 50 so as to be reciprocally movable in a direction toward the center of the main body 50.

The bumper 58 may be coupled along a part of the rim of the main body 50 or coupled along the entire rim of the main body 50.

The first sensor 121 may be coupled to the main body 50 and configured to detect a motion (relative movement) of the bumper 58 relative to the main body 50. The first sensor 121 may be a microswitch, a photo-interrupter, a tact switch, or the like.

The second sensor 122 may be coupled to the main body 50 and configured to detect the relative distance to an obstacle. The second sensor 122 may be a distance sensor.

Meanwhile, the robot cleaner 1 according to the embodiment of the present disclosure may further include a displacement sensor 126.

The displacement sensor 126 may be disposed on the bottom surface (rear surface) of the main body 50 and measure a distance by which the robot cleaner moves along the floor surface.

For example, an optical flow sensor (OFS) for acquiring image information on the floor surface using light may be used as the displacement sensor 126. In this case, the optical flow sensor (OFS) includes an image sensor configured to acquire image information on the floor surface by capturing an image of the floor surface, and one or more light sources configured to adjust the amount of light.

An operation of the displacement sensor 126 will be described as an example of the optical flow sensor. The optical flow sensor is provided on the bottom surface (rear surface) of the robot cleaner 1 and captures an image of a lower portion, that is, the floor surface while the robot cleaner 1 moves. The optical flow sensor converts a lower image inputted from the image sensor and creates a predetermined lower image information.

With this configuration, the displacement sensor 126 may detect a position of the robot cleaner 1 relative to a predetermined point regardless of slippage. That is, the optical flow sensor may be used to observe the lower portion of the robot cleaner 1, such that it is possible to correct a position caused by slippage.

Meanwhile, the robot cleaner 1 according to the embodiment of the present disclosure may further include an angle sensor 127.

The angle sensor 127 may be disposed in the main body 50 and measure a movement angle of the main body 50.

For example, a gyro sensor for measuring a rotational velocity of the main body 50 may be used as the angle sensor 127. The gyro sensor may detect the direction of the robot cleaner 1 using the rotational velocity.

With this configuration, based on a predetermined imaginary line, the angle sensor 127 may detect a direction in which the robot cleaner 1 moves and an angle at which the robot cleaner 1 moves.

Meanwhile, the present disclosure may further include the imaginary connection line L1 that connects rotation axes of the pair of rotary plates 10 and 20. Specifically, the connection line L1 may mean an imaginary line that connects the rotation axis of the first rotary plate 10 and the rotation axis of the second rotary plate 20.

The connection line L1 may be a criterion based on which the front and rear sides of the robot cleaner 1 are defined. For example, a side at which the first lower sensor 123 is disposed based on the connection line L1 may be referred to as the front side of the robot cleaner 1, and a side at which the water container 141 is disposed based on the connection line L1 may be referred to as the rear side of the robot cleaner 1.

Therefore, based on the connection line L1, the first lower sensor 123, the second lower sensor 124, and the third lower sensor 125 may be disposed at a front lower side of the main body 50, the first sensor 121 may be disposed inside a front outer circumferential surface of the main body 50, and the second sensor 122 may be disposed at a front upper side of the main body 50. In addition, based on the connection line L1, the battery 135 may be inserted and coupled into a front side of the main body 50 in a direction perpendicular to the floor surface B. Further, based on the connection line L1, the displacement sensor 126 may be disposed at a rear side of the main body 50.

Therefore, based on the connection line L1, a surface of the main body 50 on which the first sensor 121 and the bumper 58 are positioned may be referred to as a front surface of the main body 50, and a surface of the main body 50, which is opposite to the front surface, may be referred to as a rear surface of the main body 50.

Meanwhile, the present disclosure may further include an imaginary movement direction line H that extends in parallel with the floor surface B and perpendicularly intersects the connection line L1 at an intermediate point C of the connection line L1. Specifically, the movement direction line H may include a forward movement direction line Hf extending in parallel with the floor surface B toward the side at which the battery 135 is disposed based on the connection line L1, and a rearward movement direction line Hb extending in parallel with the floor surface B toward the side at which the water container 141 is disposed based on the connection line L1. Therefore, the battery 135 and the first lower sensor 123 may be disposed in the forward movement direction line Hf, and the displacement sensor 126 and the water container 141 may be disposed in the rearward movement direction line Hb. Further, based on the movement direction line H, the first rotary plate 10 and the second rotary plate 20 may be disposed symmetrically (linearly symmetrically).

With this configuration, the movement direction line H may mean the direction in which the robot cleaner 1 moves.

That is, a state in which the robot cleaner 1 moves along the forward movement direction line Hf may be referred to as a forward movement, and a state in which the robot cleaner 1 moves along the rearward movement direction line Hb may be referred to as a rearward movement.

Meanwhile, in order to assist in understanding the present disclosure, a front end of the robot cleaner 1 according to the present disclosure will be described below. The front end of the robot cleaner 1 according to the present disclosure may mean a point farthest in distance forward from the connection line L1 in the horizontal direction. For example, the front end of the robot cleaner 1 may mean a point on an outer circumferential surface of the bumper 58 through which the forward movement direction line Hf passes.

In addition, a rear end of the robot cleaner 1 may mean a point farthest in distance rearward from the connection line L1 in the horizontal direction. For example, the rear end of the robot cleaner 1 may mean a point on an outer surface of the water container 141 through which the rearward movement direction line Hb passes.

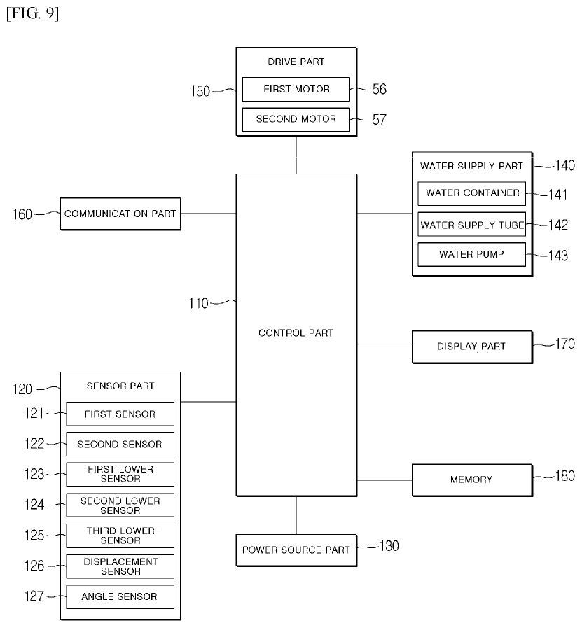

Meanwhile, FIG. 9 is a block diagram of the robot cleaner according to the present disclosure illustrated in FIG. 1.

Referring to FIG. 9, the robot cleaner 1 may include a control part 110, a sensor part 120, a power source part 130, a water supply part 140, a drive part 150, a communication part 160, a display part 170, and a memory 180. The constituent elements illustrated in the block diagram of FIG. 2 are not essential to implement the robot cleaner 1. The robot cleaner 1 described in the present specification may have the constituent elements larger or smaller in number than the constituent elements listed above.

First, the control part 110 may be disposed in the main body 50 and connected to a control device (not illustrated) in a wireless communication manner through the communication part 160 to be described below. In this case, the control part 110 may transmit various data in relation to the robot cleaner 1 to the connected control device (not illustrated). Further, the control part 110 may receive inputted data from the control device and store the data. In this case, the data inputted from the control device may be a control signal for controlling at least one function of the robot cleaner 1.

In other words, the robot cleaner 1 may receive the control signal made based on a user's input from the control device and operate based on the received control signal.

In addition, the control part 110 may control an overall operation of the robot cleaner. The control part 110 controls the robot cleaner 1 so that the robot cleaner 1 performs the cleaning operation while autonomously moving on a cleaning target surface based on set information stored in the memory 180 to be described below.

Meanwhile, in the present disclosure, a process of controlling a straight movement by the control part 110 will be described below.

The sensor part 120 may include one or more of the first lower sensor 123, the second lower sensor 124, the third lower sensor 125, the first sensor 121, and the second sensor 122 of the robot cleaner 1 which are described above.

In other words, the sensor part 120 may include a plurality of different sensors capable of detecting the environment at the periphery of the robot cleaner 1. Information on the environment at the periphery of the robot cleaner 1 detected by the sensor part 120 may be transmitted to the control device by the control part 110. In this case, the information on the peripheral environment may be whether an obstacle is present, whether a cliff is detected, whether a collision is detected, or the like, for example.

The control part 110 may control the operations of the first motor 56 and/or the second motor 57 based on the information detected by the first sensor 121. For example, when the bumper 58 comes into contact with an obstacle while the robot cleaner 1 moves, the first sensor 121 may recognize a position at which the bumper 58 comes into contact with the obstacle, and the control part 110 may control the operations of the first motor 56 and/or the second motor 57 so that the robot cleaner 1 departs from the contact position.

In addition, when a distance between the robot cleaner 1 and the obstacle is a predetermined value or less based on the information detected by the second sensor 122, the control part 110 may control the operations of the first motor 56 and/or the second motor 57 so that the movement direction of the robot cleaner 1 is changed or the robot cleaner 1 moves away from the obstacle.

In addition, based on a distance detected by the first lower sensor 123, the second lower sensor 124, or the third lower sensor 125, the control part 110 may control the operations of the first motor 56 and/or the second motor 57 so that the robot cleaner 1 is stopped or the movement direction is changed.

In addition, based on a distance detected by the displacement sensor 126, the control part 110 may control the operations of the first motor 56 and/or the second motor 57 so that the movement direction of the robot cleaner 1 is changed. For example, when the robot cleaner 1 slips and deviates from the inputted movement route or movement pattern, the displacement sensor 126 may measure a distance by which the robot cleaner 1 deviates from the inputted movement route or movement pattern, and the control part 110 may control the operations of the first motor 56 and/or the second motor 57 to compensate for the deviation.

In addition, based on an angle detected by the angle sensor 127, the control part 110 may control the operations of the first motor 56 and/or the second motor 57 so that the movement direction of the robot cleaner 1 is changed. For example, when the robot cleaner 1 slips and a direction toward the robot cleaner 1 deviates from an inputted movement direction, the angle sensor 127 may measure an angle by which the direction toward the robot cleaner 1 deviates from the inputted movement direction, and the control part 110 may control the operations of the first motor 56 and/or the second motor 57 to compensate for the deviation.

Meanwhile, under control of the control part 110, the power source part 130 receives power from an external power source or an internal power source and supplies the power required to operate the respective constituent elements. The power source part 130 may include the above-mentioned battery 135 of the robot cleaner 1.

The water supply part 140 may include the water container 141, the water supply tube 142, and the water pump 143 of the robot cleaner 1 which are described above. The water supply part 140 may be configured to adjust a feed rate of the liquid (water) to be supplied to the first mop 30 and the second mop 40 during the cleaning operation of the robot cleaner 1 based on the control signal of the control part 110. The control part 110 may control an operating time of a motor that operates the water pump 143 to adjust the feed rate.

The drive part 150 may include the first motor 56 and the second motor 57 of the robot cleaner 1 which are described above. The drive part 150 may be configured to allow the robot cleaner 1 to rotate or rectilinearly move based on the control signal of the control part 110.

Meanwhile, the communication part 160 may be disposed in the main body 50 and may include at least one module that enables wireless communication between the robot cleaner 1 and a wireless communication system, between the robot cleaner 1 and a preset peripheral device, or between the robot cleaner 1 and a preset external server.

For example, the module may include at least one of an IR (infrared) module for infrared communication, an ultrasonic module for ultrasonic communication, and a short distance communication module such as a WiFi module or a Bluetooth module. Alternatively, the module may include a wireless Internet module to transmit and receive data to/from the preset devices through various wireless technologies such as WLAN (wireless LAN) or Wi-Fi (wireless fidelity).

Meanwhile, the display part 170 displays information to be provided to the user. For example, the display part 170 may include a display for displaying a screen. In this case, the display may be exposed from an upper surface of the main body 50.

In addition, the display part 170 may include a speaker configured to output sound. For example, the speaker may be embedded in the main body 50. In this case, the main body 50 may have a hole that is formed to correspond to a position of the speaker allows sound to pass therethrough. A source of the sound outputted by the speaker may be sound data pre-stored in the robot cleaner 1. For example, the pre-stored sound data may be related to audio guidance corresponding to the respective functions of the robot cleaner 1 or alarm sound indicating errors.

In addition, the display part 170 may include any one of a light-emitting diode (LED), a liquid crystal display (LCD), a plasma display panel, and an organic light-emitting diode (OLED).

The memory 180 may include various data for driving and operating the robot cleaner. The memory 180 may include application programs and various related data for allowing the robot cleaner 1 to autonomously move. In addition, the memory 180 may store respective data detected by the sensor part 120 and include set information about various set values (e.g., reserved cleaning time, cleaning modes, feed rates, LED brightness, volume sizes of notification sound, and the like) selected or inputted by the user.

Meanwhile, the memory 180 may include information about a cleaning target surface given to the current robot cleaner 1. For example, the information about the cleaning target surface may be map information autonomously mapped by the robot cleaner 1. Further, the map information, that is, the map may include various information set by the user in respect to the respective regions constituting the cleaning target surface.

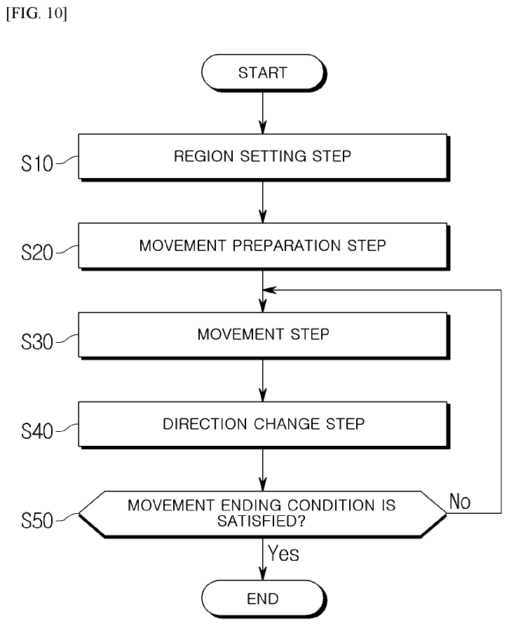

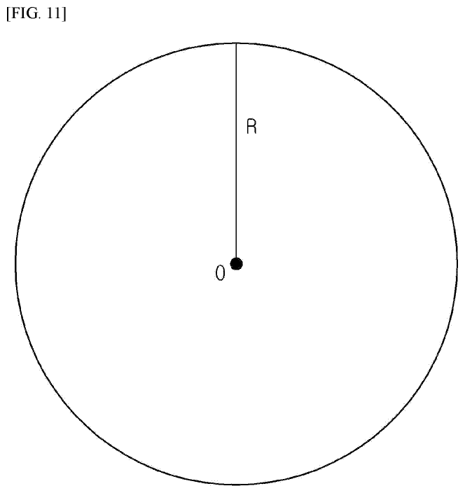

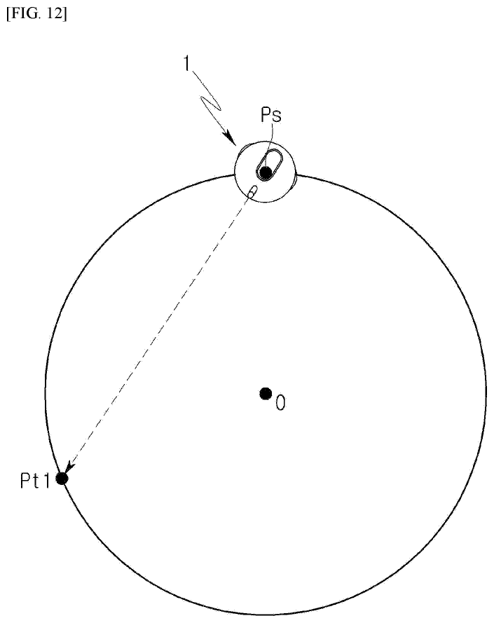

Meanwhile, FIG. 10 is a flowchart illustrating a method of controlling the robot cleaner according to the embodiment of the present disclosure, FIG. 11 is a view for explaining a process in which the robot cleaner sets a cleaning region in accordance with the method of controlling the robot cleaner according to the embodiment of the present disclosure, and FIGS. 12 to 16 are views for schematically explaining routes along which the robot cleaner moves in accordance with the method of controlling the robot cleaner according to the embodiment of the present disclosure.

A method of controlling the robot cleaner according to the embodiment of the present disclosure will be described below with reference to FIGS. 1 to 16.

The method of controlling the robot cleaner according to the embodiment of the present disclosure includes a region setting step S10, a movement preparation step S20, a movement step S30, a direction change step S40, and a movement ending step S50.

In the region setting step S10, the control part 110 may set an imaginary cleaning region on the floor surface B.

For example, in the region setting step S10, the user may set the cleaning region by inputting a coordinate of a particular position or a particular structure through a terminal (not illustrated) or the like. Further, the user may input, through the terminal (not illustrated) or the like, a cleaning target which is a specific position on the floor surface to be concentratedly cleaned. Further, the user may input a radius R around the cleaning target to be cleaned.

Alternately, in the region setting step S10 the control part 110 may detect a degree of contamination of the floor surface B and set a specific position with a high degree of contamination as the cleaning target. The control part 110 may set the radius R around the cleaning target to be cleaned.

In this case, the control part 110 may set the cleaning region by forming an imaginary circle on the floor surface B around the specific position (S12). Specifically, the control part 110 may set a specific position as an origin o and form an imaginary circle having a predetermined radius R around the origin o (see FIG. 11). Therefore, the cleaning region may be a circular region having a predetermined radius on the floor surface.

Further, in the region setting step S10, the control part 110 may set an initial starting point Ps. For example, the control part 110 may set a point in the cleaning region positioned at the shortest distance from the current position of the robot cleaner 1 as the initial starting point Ps.

Therefore, the initial starting point Ps may be positioned on an outer periphery of the cleaning region. That is, the initial starting point Ps may be positioned on a circumference of the imaginary circle having the predetermined radius R around the origin o.

Next, in the movement preparation step S20, the control part 110 may dispose the robot cleaner 1 at the initial starting point.

In the case in which the robot cleaner 1 is not positioned at the initial starting point Ps, the control part 110 may control and move the robot cleaner 1 to the initial starting point Ps.

Meanwhile, when the robot cleaner 1 is positioned at the initial starting point Ps, the control part 110 may perform control so that the front surface 51 of the main body 50 is directed toward an initial direction change point Pt1.

For example, the control part 110 may perform control so that the movement direction line H of the robot cleaner 1 is directed toward the initial direction change point Pt1. Specifically, the control part 110 may calculate an angle difference between the movement direction line H and the initial direction change point Pt1 and operate the first motor 56 and/or the second motor 57 to rotate the robot cleaner 1 by the angle difference so that the movement direction line H and the initial direction change point Pt1 are coincident with each other.

In this case, the control part 110 may operate the first motor 56 and the second motor 57 in the same rotation direction and at the same rotational velocity to rotate the robot cleaner 1 in place. That is, the first rotary plate 10 and the second rotary plate 20 may rotate the robot cleaner 1 in place while rotating in the equal rotation direction and at the equal rotational velocity.

Meanwhile, in the embodiment, the control part 110 may perform control for compensating for slippage when the robot cleaner 1 slips when rotating in place.

Further, when the front surface 51 of the main body 50 is directed toward the initial direction change point Pt1, the control part 110 may start the movement step S30.

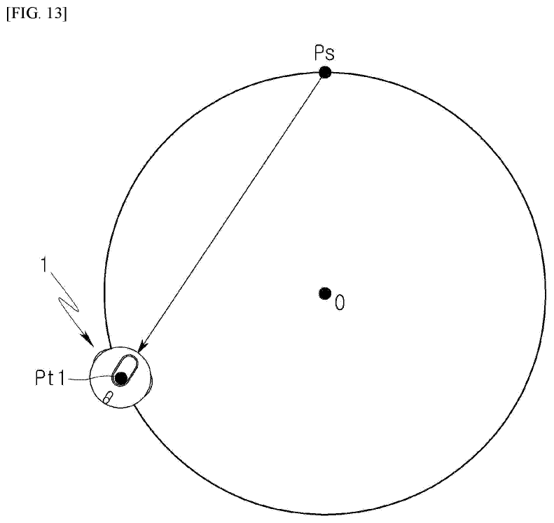

In the movement step S30, the control part 110 may allow the robot cleaner 1 to start from the starting point Ps (Ptn−1) positioned on the outer periphery of the cleaning region set on the floor surface and move to the direction change point Pt1 (Ptn) positioned on the outer periphery of the cleaning region (see FIGS. 12 and 13).

For example, after the movement preparation step S20, the robot cleaner 1 may start from the initial starting point Ps and move to the initial direction change point Pt1.

As another example, when the movement step S30 is performed n times after the direction change step S40 is repeated n−1 times, the robot cleaner 1 may start from the reset starting point Ptn−1 and move to the nth direction change point Ptn.

In this case, both the starting point Ps (Ptn−1) and the direction change point Pt1 (Ptn) are positioned at the outer periphery of the cleaning region, but a position of the starting point Ps (Ptn−1) and a position of the direction change point Pt1 (Ptn) may be different from each other. That is, the starting point Ps (Ptn−1) and the direction change point Pt1 (Ptn) are positioned on a circumference of a concentric circle having a predetermined radius R around the origin o, but the position of the starting point Ps (Ptn−1) and the position of the direction change point Pt1 (Ptn) may be different from each other. In this case, a region in which the robot cleaner 1 moves may at least partially overlap a region in which the robot cleaner 1 has previously moved. Therefore, the robot cleaner 1 may repeatedly clean the severely contaminated floor surface, thereby improving cleaning performance.

In the movement step S30, when the robot cleaner 1 starts to move, the control part 110 may rotate the first motor 56 and the second motor 57 in opposite directions. For example, the robot cleaner 1 may move forward when the first rotary plate 10 rotates counterclockwise and the second rotary plate 20 rotates clockwise when viewed from above the ground surface.

In the movement step S30, the control part 110 may allow the robot cleaner 1 to start from the starting point Ps (Ptn−1) and move to the direction change point Pt1 (Ptn) (S31).

For example, in the movement step S30, the control part 110 may move the robot cleaner rectilinearly from the starting point Ps (Ptn−1) to the direction change point Pt1 (Ptn). In this case, the first rotary plate 10 and the second rotary plate 20 may be rotated in opposite directions, and a rotational velocity col of the first rotary plate 10 and a rotational velocity ω2 of the second rotary plate 20 may be equal to each other ω1=ω2). That is, in the movement step S30, the control part 110 may operate the first motor 56 and the second motor 57 with the same output. Further, in the movement step S30, a relative movement velocity v1 of the first mop 30 to the floor surface B may be equal to a relative movement velocity v2 of the second mop 40 to the floor surface B (v1=v2).

As another example, the control part 110 may move the robot cleaner 1 from the starting point Ps (Ptn−1) to the direction change point Pt1 (Ptn) along a route having a predetermined curvature. In this case, the first rotary plate 10 and the second rotary plate 20 may rotate in opposite directions in such a way that the rotational velocities of the first rotary plate 10 and the second rotary plate 20 are different from each other. In this case, a difference (ω1-ω2=□ω) in rotational velocities between the first rotary plate 10 and the second rotary plate 20 may be constant.

In the movement step S30, the control part 110 may stop the movement of the robot cleaner 1 depending on a distance from the origin o of the cleaning region which is detected by the displacement sensor 126. For example, in the movement step S30, the control part 110 may stop the movement of the robot cleaner 1 when the distance from the origin o to the robot cleaner 1, which is detected by the displacement sensor 126, is equal to the radius R of the cleaning region (S32).

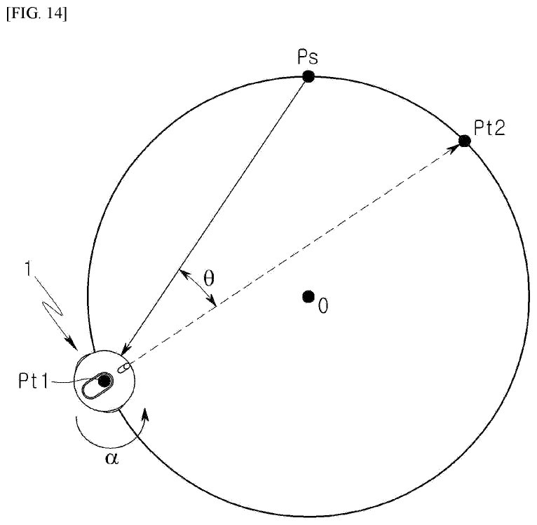

Meanwhile, in the direction change step S40, the control part 110 may rotate the robot cleaner at the direction change point toward the inside of the cleaning region after the movement step S30 (see FIG. 14).

In the direction change step S40, the control part 110 may rotate the robot cleaner 1. That is, the robot cleaner 1 may move to the direction change point Pt1 (Ptn) in the movement step S30 and then rotate in the direction change step S40.

Specifically, in the direction change step S40, the robot cleaner 1 may rotate in a state of being stationary on the floor surface. That is, in the direction change step S40, the control part 110 may control and operate the first motor 56 and the second motor 57 in the same direction. In this case, the pair of rotary plates 10 and 20 may rotate in the same direction. Therefore, the first mop 30 and the second mop 40 may rotate in the same direction.

For example, in order to rotate the robot cleaner 1 counterclockwise when viewed from the top side perpendicular to the ground surface (floor surface), the control part 110 may operate the first motor 56 and the second motor 57 to rotate the first rotary plate 10 and the second rotary plate 20 clockwise. Therefore, the first mop 30 and the second mop 40 rotate clockwise together with the first rotary plate 10 and the second rotary plate 20 and relatively rotate while generating friction with the floor surface B, thereby rotating the robot cleaner 1 counterclockwise.

As another example, in order to rotate the robot cleaner 1 clockwise when viewed from the top side perpendicular to the ground surface (floor surface), the control part 110 may operate the first motor 56 and the second motor 57 to rotate the first rotary plate 10 and the second rotary plate 20 counterclockwise. Therefore, the first mop 30 and the second mop 40 rotate counterclockwise together with the first rotary plate 10 and the second rotary plate 20 and relatively rotate while generating friction with the floor surface B, thereby rotating the robot cleaner 1 clockwise.

In the direction change step S40, the control part 110 may rotate the pair of rotary plates 10 and 20 at the same velocity (ω1=ω2) at the time of initiating the rotation. That is, in the direction change step S40, the control part 110 may operate the first motor 56 and the second motor 57 with the same output. Further, in the direction change step S40, the relative movement velocity v1 of the first mop 30 to the floor surface B may be equal in magnitude (absolute value) to the relative movement velocity v2 of the second mop 40 to the floor surface B.

On the contrary, in the direction change step S40, the robot cleaner 1 may rotate while moving on the floor surface. That is, in the direction change step S40, the control part 110 may control the first motor 56 and the second motor 57 to rotate the pair of rotary plates 10 and 20 in opposite directions or the same direction in such a way that the rotational velocities of the pair of rotary plates 10 and 20 are different from each other. In this case, the robot cleaner 1 may rotate while forming an arc on the floor surface.

In the direction change step S40, the control part 110 may rotate the robot cleaner 1 toward the inside of the cleaning region (S41).

Specifically, after the movement step S30, the robot cleaner 1 is positioned at the direction change point Pt1 (Ptn) on the outer periphery of the cleaning region. At this point in time, the front surface 51 of the main body 50 of the robot cleaner 1 is directed toward the outside of the cleaning region. That is, at a point in time at which the movement step S30 is ended, the front surface 51 of the main body 50 is directed toward a portion distant from the origin o of the cleaning region.

In this case, when the direction change step S40 is started, the control part 110 may rotate the front surface 51 of the main body 50 in a direction close to the origin o. For example, in a case in which the origin o is positioned at the right side based on the movement direction line H, the control part 110 may rotate the main body 50 clockwise. Further, in a case in which the origin o is present at the left side based on the movement direction line H, the control part 110 may rotate the main body 50 counterclockwise. With the above-mentioned configuration, it is possible to reduce the time required to rotate the robot cleaner 110.

Further, in the direction change step S40, the control part 110 may rotate the main body 50 of the robot cleaner 1 by a preset direction change angle α based on a direction in which the front surface 51 of the main body 50 of the robot cleaner 1 is directed.

In this case, all the angles may be applied as the direction change angle α as long as the angle is an angle by which the front surface 51 of the main body 50 rotates to be close to the origin o. However, the direction change angle α may be larger than 90 degrees and smaller than 180 degrees. If the direction change angle α is 90 degrees or less, the robot cleaner 1 cannot move in an area at the periphery of the origin o of the cleaning region but moves only in an outer peripheral area of the cleaning region, and as a result, there is a problem in that the robot cleaner cannot clean an area at the periphery of the origin o with a high degree of contamination. In addition, if the direction change angle α is 180 degrees, the robot cleaner returns back to the starting point Ps (Ptn−1), and as a result, there is a problem in that the robot cleaner cannot clean a wide area.

As a result, in a state in which the movement step S30 is ended, the front surface 51 of the main body 50, which is directed outward in a radial direction in the circular cleaning region, may be rotated to be directed toward the inside of the cleaning region in the direction change step S40.

Meanwhile, in the direction change step S40, the control part 110 may rotate the robot cleaner 1 by the direction change angle α and then set a point at which the movement direction line H intersects an outer peripheral boundary of the cleaning region as a next direction change point (S42).

Specifically, after the robot cleaner 1 is rotated in the direction change step S40, the movement direction line H intersects the outer peripheral boundary of the circular cleaning region at two points. In this case, because the robot cleaner 1 is placed at one intersection point, the other intersection point may be set as the next direction change point (Ptn+1).

That is, after the robot cleaner 1 is rotated at the current direction change point Pt1 (Ptn) in the direction change step S40, the control part 110 may set the intersection point between the movement direction line H and the outer peripheral boundary of the cleaning region as a next direction change point Pt2 (Ptn+1). In this case, the next direction change point Pt2 (Ptn+1) may be different from the starting point Ps (Ptn−1) in the movement step S30.

Further, when the current direction change point Pt1 (Ptn) is set as a vertex, an angle θ, which is defined between two sides connected to the starting point Ps (Ptn−1) and the next direction change point Pt2 (Ptn+1) in the movement step S30, may be 180°-α (see FIG. 14). In this case, the angle θ may be larger than 0 degree and smaller than 90 degrees. If the angle θ is 0 degree, the next direction change point Pt2 (Ptn+1) is identical to the starting point Ps (Ptn−1) in the movement step S30, and as a result, the robot cleaner 1 merely reciprocates between the two points, and a wide area of the circular cleaning region cannot be cleaned. In addition, if the angle θ is 90 degrees or more, the robot cleaner 1 cannot move in the area at the periphery of the origin o of the cleaning region but moves only in the outer peripheral area of the cleaning region, and as a result, there is a problem in that the area at the periphery of the origin o with a high degree of contamination cannot be cleaned.

Further, after the robot cleaner 1 is rotated at the current direction change point Ptn in the direction change step S40, the control part 110 may reset the current direction change point Ps (Ptn) as a next starting point.

For example, after the control part 110 rotates the robot cleaner 1 at the initial direction change point Pt1 by the direction change angle α in the direction change step S40, the control part 110 may set the point at which the movement direction line H intersects the outer peripheral boundary of the cleaning region as the second direction change point Pt2 and reset the initial direction change point Pt1 as a second starting point.

As another example, after the control part 110 rotates the robot cleaner 1 at the nth direction change point Ptn by the direction change angle α in the direction change step S40 that has been repeated n times, the control part 110 may set the point at which the movement direction line H intersects the outer peripheral boundary of the cleaning region as the (n+1)th direction change point (Ptn+1) and reset the nth direction change point Ptn as the (n+1)th starting point.

Meanwhile, the method of controlling the robot cleaner according to the embodiment of the present disclosure may perform the movement step S30 again after the direction change step S40.

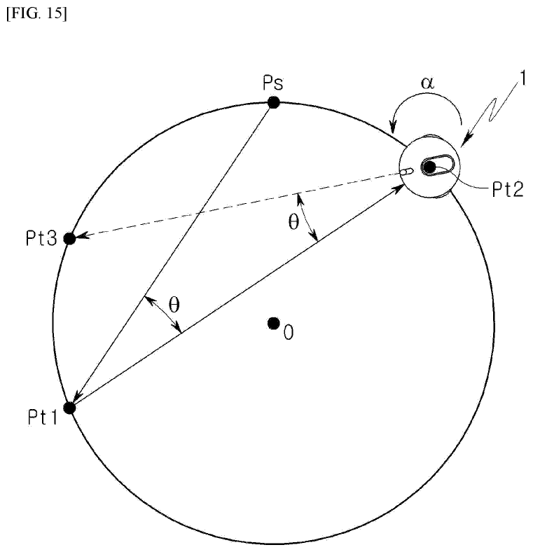

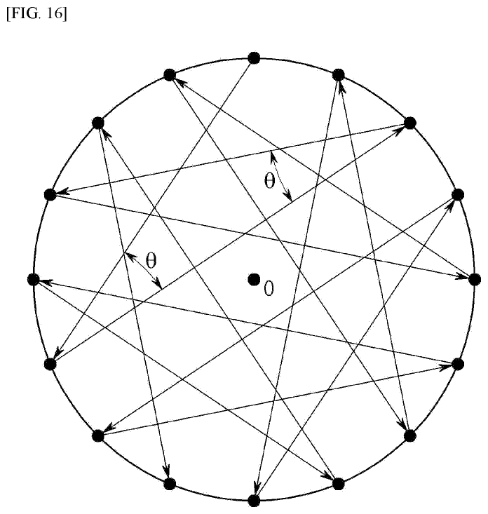

Further, the method of controlling the robot cleaner 1 according to the embodiment of the present disclosure may repeat the movement step S30 and the direction change step S40 until a condition of the movement ending step S50 to be described below is satisfied (see FIGS. 15 and 16).

That is, the main body 50 of the robot cleaner 1 rectilinearly moves in the predetermined cleaning region on the floor surface (the movement step S30), the main body 50 of the robot cleaner 1 rotates toward the inside of the cleaning region (the direction change step S40) when the main body 50 of the robot cleaner 1 reaches the outer peripheral boundary of the cleaning region, and then the main body 50 of the robot cleaner 1 may repeatedly move rectilinearly again (the movement step S30).

Meanwhile, during the process of repeating the movement step S30 and the direction change step S40, the regions on the floor surface in which the robot cleaner 1 has moved may at least partially overlap one another. As a result, the cleaning region may be repeatedly cleaned, such that the cleaning region may be precisely cleaned.

Meanwhile, when a predetermined condition is satisfied in the movement ending step S50, the control part 110 may end the movement and/or the rotation of the robot cleaner 1.

For example, in the movement ending step S50, the control part 110 may end the movement and/or the rotation of the robot cleaner 1 after repeating the movement step S30 a predetermined number of times.

In this case, the number of times the movement step S30 is repeated may be inputted in advance by the user through the terminal (not illustrated) or the like.

Alternately, the number of times the movement step S30 is repeated may be set by the control part 110 in the region setting step S10 based on the detected degree of contamination of the floor surface B.

As another example, in the movement ending step S50, the control part 110 may end the movement and/or the rotation of the robot cleaner 1 when a predetermined cleaning time t elapses after the robot cleaner 1 starts from the initial starting point Ps.

As still another example, in the movement ending step S50, the control part 110 may end the movement and/or the rotation of the robot cleaner 1 when the robot cleaner 1 returns to the initial starting point Ps.

As yet another example, the control part 110 may detect a degree of contamination of the floor surface B in the movement step S30 or the direction change step S40. When the detected degree of contamination is a predetermined reference value or less, the control part 110 determines that the floor surface B is sufficiently cleaned, and the control part 110 ends the movement and/or the rotation of the robot cleaner 1 in the movement ending step S50.

Meanwhile, in the movement ending step S50, the control part 110 may end the movement in the cleaning region and/or the operation of cleaning the cleaning region and move the robot cleaner 1 to a preset position. For example, when the control part 110 ends the movement in the cleaning region and/or the operation of cleaning the cleaning region, the control part 110 may control and move the robot cleaner 1 to a charging stand (not illustrated) for the robot cleaner.

An effect of the method of controlling the robot cleaner according to the embodiment of the present disclosure will be described below.

According to the method of controlling the robot cleaner according to the embodiment of the present disclosure, the main body 50 of the robot cleaner 1 may rectilinearly move in the predetermined cleaning region on the floor surface, the main body 50 of the robot cleaner 1 may rotate toward the inside of the cleaning region when the main body 50 of the robot cleaner 1 reaches the outer peripheral boundary of the cleaning region, and then the main body 50 of the robot cleaner 1 may repeatedly move rectilinearly again.

Therefore, since the robot cleaner 1 moves across the cleaning region from the origin o on the floor surface B while moving between the plurality of direction change points Pt disposed at a predetermined distance, the robot cleaner 1 may clean the circular cleaning region while repeatedly moving in the circular cleaning region.

Further, in the present disclosure, since the direction change step S40 allows the robot cleaner 1 to move after rotating by a predetermined angle or a random angle, the robot cleaner 1 may clean the cleaning region while moving in various directions in the cleaning region, thereby cleaning a wide area.

In addition, since the movement step S30 and the direction change step S40 allow the robot cleaner 1 to move across the circular cleaning region in various directions, the regions in which the robot cleaner 1 moves at least partially overlap. As a result, the severely contaminated floor surface may be precisely cleaned.

In addition, the robot cleaner 1 rotates clockwise or counterclockwise in the direction close to the origin o in the direction change step S40, thereby reducing the time required for the cleaning operation.

In addition, since the robot cleaner 1 repeatedly moves from the origin o toward the plurality of direction change points Pt disposed on the predetermined radius R, the central portion of the cleaning region including the origin o may be cleaned repeatedly. Therefore, even when the central portion of the cleaning region including the origin o is widely contaminated, the central portion of the cleaning region may be precisely cleaned.

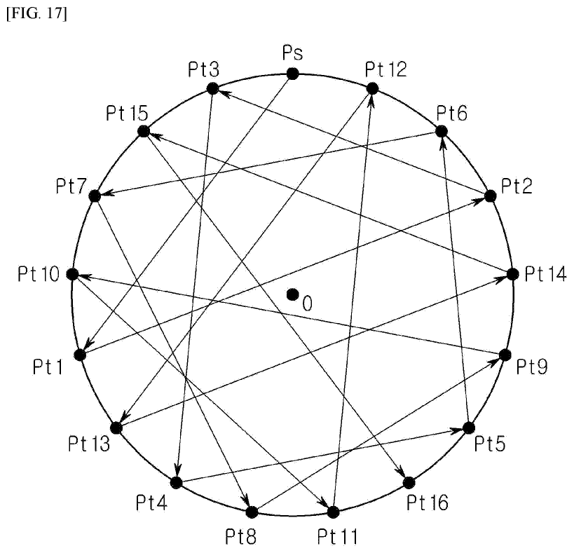

Meanwhile, FIG. 17 is a view for schematically explaining a route along which the robot cleaner moves in accordance with a method of controlling the robot cleaner according to another embodiment of the present disclosure.

The method of controlling the robot cleaner according to another embodiment of the present disclosure will be described below with reference to FIGS. 10 and 17.

The method of controlling the robot cleaner according to another embodiment of the present disclosure includes the region setting step S10, the movement preparation step S20, the movement step S30, the direction change step S40, and the movement ending step S50.

Meanwhile, because the contents the method of controlling the robot cleaner according to the present embodiment are identical to the contents of the method of controlling the robot cleaner according to the above-mentioned embodiment of the present disclosure except for the contents particularly described in the present embodiment, the description of the contents of the method of controlling the robot cleaner according to the above-mentioned embodiment may be replaced with the description of the contents of the method of controlling the robot cleaner according to the present embodiment.

In the direction change step S40 in the present embodiment, the control part 110 may rotate the robot cleaner 1 by a random angle based on the direction in which the front surface 51 of the main body 50 of the robot cleaner 1 is directed.

The random angle may be a random angle selected from a table of random numbers. However, a range of the random angle in the present embodiment may be restricted so that the front surface 51 of the main body 50 rotates to be close to the origin o.

For example, the random angle may be randomly set within a range of more than 90 degrees and less than 180 degrees. If the random angle is 90 degrees or less, the robot cleaner 1 cannot move in the area at the periphery of the origin o of the cleaning region but moves only in the outer peripheral area of the cleaning region, and as a result, there is a problem in that the robot cleaner cannot clean the area at the periphery of the origin o with a high degree of contamination. In addition, if the random angle is 180 degrees, the robot cleaner returns back to the starting point Ps, and as a result, there is a problem in that the robot cleaner cannot clean a wide area.

As a result, in a state in which the movement step S30 is ended, the front surface 51 of the main body 50, which is directed outward in a radial direction in the circular cleaning region, may be rotated to be directed toward the inside of the cleaning region in the direction change step S40.

Meanwhile, the method of controlling the robot cleaner according to the present embodiment may repeatedly perform the movement step S30 and the direction change step S40 after the direction change step S40. Further, during the repeated direction change step S40, the control part 110 may rotate the robot cleaner 1 by a new random angle.

Therefore, according to the present embodiment, since the robot cleaner may move in the cleaning region after rotating by a random angle in the direction change step S40, the robot cleaner may clean all the cleaning regions.

That is, since the robot cleaner 1 rotates by the predetermined direction change angle α in the direction change step S40 according to the embodiment of the present disclosure, there may be an area in the cleaning region where the robot cleaner 1 cannot move even though the movement step S30 and the direction change step S40 are repeated. In contrast, since the rotation angle of the robot cleaner 1 is continuously changed in the direction change step S40 according to the present embodiment, an area where the robot cleaner 1 cannot move may be removed as the movement step S30 and the direction change step S40 are repeated.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

1. A robot cleaner comprising:
a main body having a bumper provided on a front surface thereof and having a space for accommodating a battery, a water container, and a motor therein; and
a pair of rotary plates rotatably disposed on a bottom surface of the main body and having lower sides to which mops facing a floor surface are coupled,
wherein the main body rectilinearly moves in a predetermined cleaning region on the floor surface, and
wherein when the main body reaches an outer peripheral boundary of the cleaning region, the main body rotates toward an inside of the cleaning region and then moves rectilinearly.

2. The robot cleaner of claim 1, wherein the cleaning region is a circular region having a predetermined radius on the floor surface.

3. The robot cleaner of claim 1, wherein the main body rotates by a preset angle at an outer peripheral boundary of the cleaning region.

4. A robot cleaner comprising:
a main body having a bumper provided on a front surface thereof and having a space for accommodating a battery, a water container, and a motor therein; and
a pair of rotary plates rotatably disposed on a bottom surface of the main body and having lower sides to which mops facing a floor surface are coupled,
wherein the main body moves in a circular cleaning region having a predetermined radius on the floor surface, and
wherein the main body starts from a predetermined starting point on a circumference of the cleaning region and moves to a predetermined direction change point on the circumference of the cleaning region.

5. The robot cleaner of claim 4, wherein after the main body reaches the direction change point, the main body moves to any one point on the circumference of the cleaning region, which is different from the direction change point and the starting point.

6. A method of controlling a robot cleaner comprising a pair of rotary plates having lower sides to which mops facing a floor surface are coupled, the robot cleaner being configured to move by rotating the pair of rotary plates, the method comprising:
a movement step of allowing the robot cleaner to start from a starting point positioned on an outer periphery of a cleaning region set on the floor surface and move to a direction change point positioned on the outer periphery of the cleaning region; and
a direction change step of rotating the robot cleaner at the direction change point toward an inside of the cleaning region.

7. The method of claim 6, wherein the robot cleaner moves rectilinearly to the predetermined direction change point in the movement step.

8. The method of claim 6, further comprising:
a region setting step of setting the cleaning region on the floor surface before the movement step.

9. The method of claim 8, wherein the region setting step sets the cleaning region by forming an imaginary circle having a predetermined radius around a predetermined origin.

10. The method of claim 6, further comprising:
a movement preparation step of disposing the robot cleaner at an initial starting point before the movement step.

11. The method of claim 6, wherein the direction change step rotates the robot cleaner by a predetermined direction change angle.

12. The method of claim 6, wherein the direction change step rotates the robot cleaner by a random angle.

13. The method of claim 6, wherein the direction change step resets any one point on the outer periphery of the cleaning region as the direction change point and rotates the robot cleaner toward the direction change point.

14. The method of claim 6, wherein the movement step is performed again after the direction change step, and the movement of the robot cleaner is ended after the movement step is repeated a predetermined number of times.

15. The method of claim 6, wherein the movement step is performed again after the direction change step, and the movement of the robot cleaner is ended when a predetermined cleaning time elapses after the robot cleaner starts from an initial starting point.
